(19) United States
(12) Patent Application Publication
(10) Pub. No.: US 2007/0218822 A1
(43) Pub. Date: Sep. 20, 2007

(54) Coin sorter and apparatus for controlling the same

(76) Inventors: Woon Gi Kim, Incheon-si (KR); Jeong Suk Ryou, Seoul (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/384,726

(22) Filed: Mar. 20, 2006

(51) Int. Cl. G07D 3/00

(52) U.S. Cl. 453/10

(57) ABSTRACT

A coin sorter includes a coin supply portion through which coins that will be sorted are supplied, a coin sorting unit for sorting the supplied coins by size, a guide unit for guiding the sorted coins to a predetermined location, a coin receiving tube for receiving the sorted coins delivered from the guide unit, a coin receiving tube moving unit for moving the coin receiving tubes frontward, and a coin receiving tube insertion unit through which the coin receiving tubes can be inserted.

### BACKGROUND OF THE INVENTION

1. Field of the Invention

The present invention relates to a coin sorter, and more particularly, to a coin sorter that can be controlled by a sensing unit, count coins received, and quickly and continuously sort a large number of coins by a user's simple manual operation.

2. Description of the Related Art

Generally, a coin sorter is used to sort a large number of coins by size. The coin sorters are widely used in banks or other commercial markets to quickly and accurately sort the coins.

A typical coin sorter includes a coin sorting unit for classifying coins by size and a coin receiving unit for allowing the coins to be received in corresponding receiving tubes. The coin sorting unit and the coin receiving unit are manually operated by the user or automatically operated by electric power.

Recently, in order to quickly sort a large number of coins and for the user's convenience, the automatic coin sorter has been used.

The automatic coin sorter is disclosed in PCT publication No. WO/2004/100085, filed by the applicant of this application on Nov. 18, 2004 and entitled “COIN SORTER, APPARATUS FOR CONTROLLING THE SAME AND METHOD OF SORTING COINS” the disclosure of which is incorporated by reference herein in its entirety.

However, the coin sorter disclosed in the published patent has the following problems. First, when the operation of the coin sorter stops after the predetermined number of coins is received in the coin receiving tubes, the operation of the coin sorter starts again only when the user manually pulls a drawing handle of a receiving container. Second, since the user manually pulls the drawing handle of the receiving container to place the coin receiving tubes below a guide unit, the receiving tubes may not be accurately aligned with the guide unit. Moreover, when the user pulls the drawing handle too hard, the receiving container may be damaged or broken. Third, the prior art coin sorter cannot output the number and amount of sorted coins. Fourth, the prior art automatic coin sorter has many functions that are done by the manual operation, the operation is inconvenient for the user and the coin sort is not quickly done.

### SUMMARY OF THE INVENTION

Accordingly, the present invention is directed to a coin sorter and an apparatus for controlling the same that substantially obviate one or more problems due to limitations and disadvantages of the related art.

An object of the present invention is to provide a coin sorter and an apparatus for controlling the same, which can automatically and continuously sort coins by automatically moving coin receiving tubes receiving the predetermined number of coins.

Still another object of the present invention is to provide a coin sorter and an apparatus for controlling the same, that can quickly sort the coins and provide the convenience to the user by omitting a receiving container and thus avoiding the manual operation for receiving or taking out coin receiving tubes in or out of the receiving container by a simple manipulation of a user separating and inserting the coin receiving tubes.

Still another object of the present invention is to provide a coin sorter and an apparatus for controlling the same, which can continuously sort the coins by a user's simple manipulation for removing or inserting the coin receiving tubes.

Still yet another object of the present invention is to provide a coin sorter and an apparatus for controlling the same, which can output the number and amount of the sorted coins to an outer display device using a communication port.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a coin sorter including: a coin supply portion through which coins that will be sorted are supplied; a coin sorting unit for sorting the supplied coins by size; a guide unit for guiding the sorted coins to a predetermined location; a coin receiving tube for receiving the sorted coins delivered from the guide unit; a coin receiving tube moving unit for moving the coin receiving tubes frontward; and a coin receiving tube insertion unit through which the coin receiving tubes can be inserted.

According to another aspect of the present invention, there is provided a coin sorter including: a coin sorting unit for sorting coins by size; a guide unit for guiding the sorted coins to a predetermined location; a coin receiving tube for receiving the sorted coins guided by the guide unit; a sensor unit for detecting if the coin receiving tube is placed at a proper location for receiving the sorted coins; a coin receiving tube moving unit for moving the coin receiving tubes frontward; a coin receiving tube insertion unit through which the coin receiving tubes can be inserted; and a control unit for controlling the operation of the coin sorting unit and the coin receiving tube moving unit according to a signal transmitted from the sensor unit.

According to still another aspect of the present invention, there is provided a control apparatus for a coin sorter, the control apparatus including: a counter sensor for counting the number of coins that is being sorted; a sensor unit for detecting if the coin receiving tube is placed at a proper location for receiving the sorted coins; a control unit for controlling the operation of the coin sorter according to signals transmitted from the counter sensor and the sensor unit; a coin sorting unit selectively operated by the control unit; and a coin receiving tube moving unit controlled by the control unit.

According to the present invention, a large number of coins can be quickly sorted by the control apparatus without the user's manipulation. Moreover, the coin sort can be done without stopping by the user's simple manipulation, thereby continuously and quickly sorting a large number of coins.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a coin sorter according to an embodiment of the present invention;

FIG. 2 is a sectional view taken along line I-I of FIG. 1;

FIG. 3 is a view illustrating an operation of a counter sensor according to the present invention;

FIG. 4 is a perspective view of a coin receiving tube depicted in FIG. 2;

FIG. 5 is a side view of FIG. 4;

FIG. 6 is a front view of FIG. 4;

FIG. 7 is a top view of FIG. 4, illustrating an installing position of a second position sensor and a sensor reflection plate;

FIG. 8 is a sectional view taken along line II-II′ of FIG. 1;

FIG. 9 is a view illustrating the operation of a sensor unit;

FIGS. 10 through 11 are views illustrating a process for placing a second coin receiving tube below the guide unit;

FIGS. 12 through 14 are views illustrating a process for receiving the coins into the second coin receiving tube disposed below the guide unit;

FIGS. 15 through 18 are views illustrating the movement, separation and insertion of the coin receiving tubes;

FIG. 19 is a view illustrating the operation of a second position sensor;

FIG. 20 is a view of a display unit of the coin sorter according to an embodiment of the present invention;

FIG. 21 is a view of a control apparatus of the coin sorter according to an embodiment of the present invention; and

FIG. 22 is a flowchart illustrating the operation of the coin sorter according to an embodiment of the present invention.

### DETAILED DESCRIPTION OF THE INVENTION

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. Wherever possible, the same reference numbers will be used throughout the drawings to refer to the same or like parts.

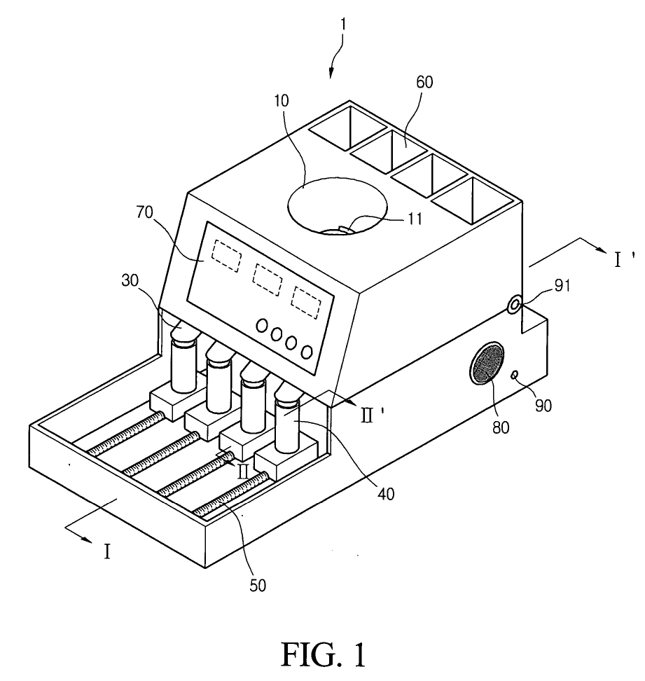

FIG. 1 is a perspective view of a coin sorter according to an embodiment of the present invention;

Referring to FIG. 1, the inventive coin sorter 1 includes a coin supply portion 10 through which the coins are supplied, a guide unit 30 for guiding the coins supplied through the coin supply portion 10 and sorted by size to a predetermined location, coin receiving tubes 40 for receiving the coins guide by the guide unit 30, a coin receiving tube moving unit 50 for moving the coin receiving tubes 50, a coin receiving tube insertion unit 60 through which new coin receiving tubes or the receiving tubes 40 separated from the coin receiving tube moving unit 50 are inserted and placed again on the coin receiving tube moving unit 50, a display unit 70 having a button manipulated by a user and displaying the number or amount of the sorted coins, a speaker 80 for generating sound according to the operation state of the coin sorter 1, and a communication port 90 for connecting the coin sorter to an outer device such as a printer to print out the amount of sorted coins.

The coin sorter 1 further includes a hinge 91 about which an upper cover of the coin sorter 1 pivots to be opened and closed. That is, there is a jammed coin, the user opens the upper cover about the hinge 91 and removes the jammed coin.

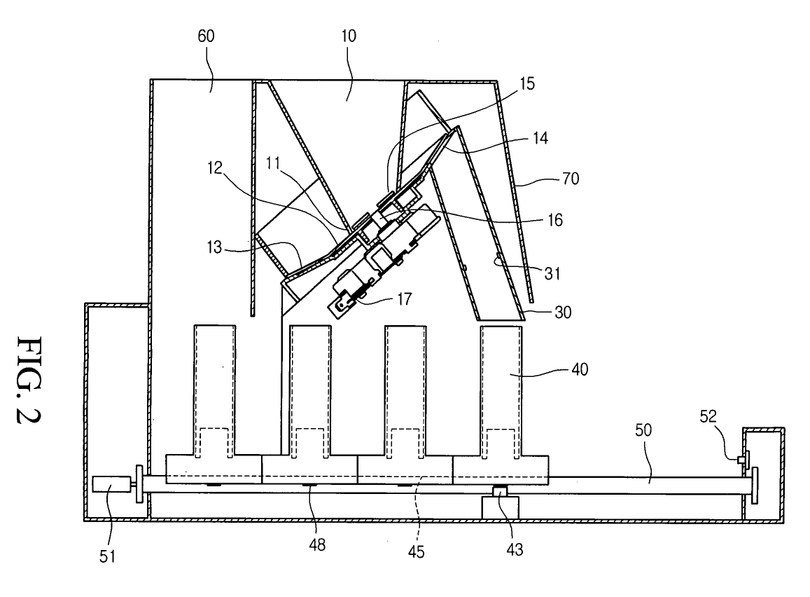

FIG. 2 is a sectional view taken along line I-I′ of FIG. 1.

Referring to FIG. 2, the coin sorter 1 further includes a projection portion 15 for supplying the coins supplied through the coin supply portion 10 to a coin supply hole 11 by a proper amount, a delivery container 12 for delivering the coins inputted through the coin input hole 11 to allow the coins to be sorted by a delivery hole 13 and sort holes 14, a rotational shaft 16 for rotating the delivery container 12, and a first motor 17 for rotating the rotational shaft 16.

In addition, the coin sorter 1 further includes a counter sensor 31 installed inside the guide unit 30 to count the number of coins sorted by size, coin receiving tubes for receiving coins sorted through the guide unit 30 by sizes, and a first position sensor 43 installed on an inner-bottom surface of the coin sorter 1 to detect the coin receiving tubes 40.

The coin sorter 1 further includes a second motor coupled to the coin receiving tube moving unit 50 to rotate the coin receiving tube moving unit 50 and a second position sensor 52 for detecting if the coin receiving tube 40 can be moved toward a front portion of the coin sorter 1 by the coin receiving tube moving unit 50.

The display unit 70 displays the number or amount of the sorted coins when the user pushes the button.

The coin receiving tubes 40 separated from the coin receiving tube moving unit 50 by the user are placed on the coin receiving tube moving unit 50 through the coin receiving tube insertion unit 60 formed on a backdoor side of the coin receiving tube moving unit 50.

The operation of the above-described coin sorter 1 will now be briefly described.

When the user 70 turns on the display unit 70 and the coins are supplied to the coin supply portion 10, the coins are sorted by size and discharged through the guide unit 30.

At this point, the coins that are being sorted by size are counted by the counter sensor 31. The number or amount of the coins that are being sorted is displayed on the display unit 70. When the predetermined number of the coins is sorted, the first motor 17 stops to suspend the sorting of the coins.

After the above, the second motor 51 operates to move the current coin receiving tube 40 receiving the sorted coins to a front portion of the coin sorter by the coin receiving tube moving unit 50. At this point, a next coin receiving tube adjacent to the current coin receiving tube 40 moves together.

Then, when it is detected by the first position sensors 43 that the next coin receiving tube is positioned at a location where the sorted coins can be properly received in the next coin receiving tube, the second motor 51 stops. As a result, the next coin receiving tube becomes a current coin receiving tube disposed below the guide unit 30.

Next, the first motor 17 operates to sort the coins. The sorted coins are received in the new current coin receiving tube.

At this point, the user withdraws the coin receiving tube 40 in which the sorted coins are received from the coin receiving tube moving unit 50 to take the sorted coins out of the coin receiving tube 40. Then, the user inserts the emptied or new coin receiving tube into the coin receiving tube moving unit 50 through the coin receiving tube insertion unit 60.

Therefore, as far as the user stands by the coin sorter, the coin receiving tubes can be continuously fed to the coin sorter and thus the coins can be sorted without stopping the coin sorter 1.

When′ the number of coins that is being sorted does not increase for a predetermined time, it is preferable that the first motor 17 stops to stop the operation of the coin sorter 1. That is, when the number of coins does not increase, this means that all of the coins supplied to the coin supply portion 10 are sorted. Therefore, when there is no increase of the number of coins, the operation of the coin sorter 1 automatically stops, thereby reducing the electric power consumption.

Furthermore, when the coin receiving tube 40 is no longer moved by the coin receiving tube moving unit 50, the second motor 51 preferably stops to stop the operation of the coin sorter 1. The second position sensor 52 detects if the coin receiving tube 40 can move by the coin receiving tube moving unit 50.

That is, when the user does not stand by the coin sorter 1, the coin receiving tube 40 received in the coin receiving tube moving unit 50 cannot be taken out of the coin receiving tube moving unit 50. In this case, it is preferable that the operation of the coin sorter 1 automatically stops. By doing this, the damage of the coin receiving tube 40 and the coin receiving tube moving unit 50, which may be caused when the coin receiving tube moving unit 50 intends to forcedly move the unmovable coin receiving tube 40 can be prevented.

The speaker 80 generates a predetermined sound, such as a voice or melody, so that the user can identify the coin sorting state.

The user can connect an outer device such as a printer to the communication port 90 to print out the amount of sorted coins.

Major parts of the above-described coin sorter 1 and the operation thereof will now be described in more detail. Since the overall structure of the coin sorter 1 is illustrated in FIG. 2, each major part will be described with reference to FIG. 2 and other accompanying drawings. First, the coin sorting unit for sorting the coins by size will be described with reference to FIG. 2.

The coin sorting unit includes the first motor 17, the rotational shaft 16 receiving a rotation power from the first motor 17, the delivery container 12 whose center is coupled to the center portion of the rotational shaft 16 and whose edge portion is provided with the delivery holes 13, and the sort holes that are different in size from each other to sort the coins by size by being aligned with the delivery hole 13.

The coin sorting unit further includes the guide unit 30 for guiding the coins falling from the sort holes 14 to a predetermined location.

The coin sorting unit further includes the projection portion 15 and the coin supply hole for supplying the coins to the delivery container 12 by a proper amount.

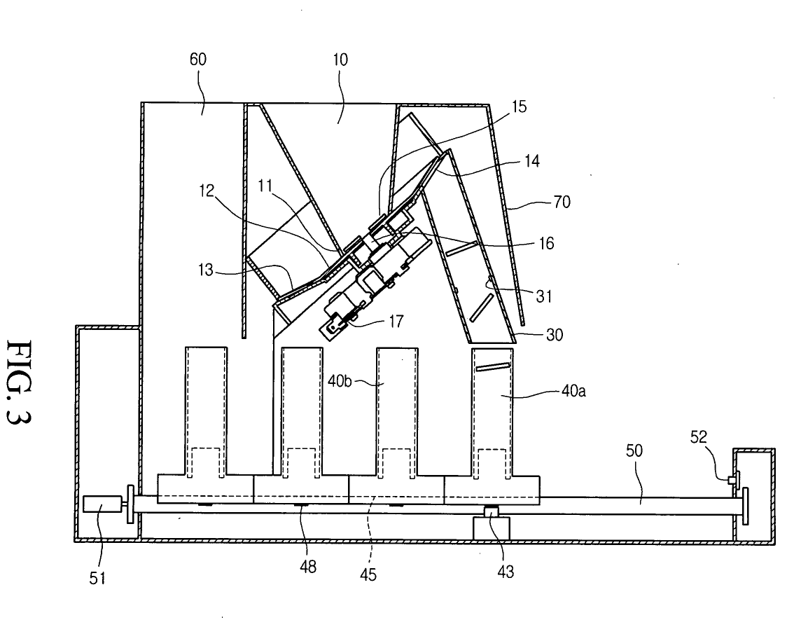

FIG. 3 is a view illustrating the operation of the counter sensor.

Referring to FIG. 3, the counter sensor 31 includes two sensor elements installed on an inner surface of the guide 30 and facing each other. The counter sensor 31 may be formed of an optical sensor. However, the present invention is not limited to this.

The two sensor elements of the counter sensor 31 mutually send and receive a signal that is interrupted for a moment when the coin passes between them, thereby detecting the number of coins that are being received in the coin receiving tube. As the counter sensor 31 is provided in the guide unit 30 allowing the coins to be sorted by size and received in the coin receiving tubes, the number of sorted/received coins can be counted.

Therefore, when the predetermined number of sorted coins is received in a first coin receiving tube 40a, the operation of the first motor 17 stops and the second motor 51 starts operating. The operation of the first and second motors 17 and 51 are controlled by a control apparatus. The number of sorted coins received in the first coin receiving tube 40a can be preset considering, for example, the packing convenience of the sorted coins.

For example, when it is detected by the counter sensor 31 that 50 coins are received in the first coin receiving tube 40a, the operation of the first motor 17 stops and the second motor 51 starts operating so that the first and second coin receiving tubes 40a and 40b move frontward. When the second coin receiving tube 40b is positioned at the location where the sorted coins can be properly received in the second coin receiving tube 40b, the operation of the second motor 51 stops and the first motor 17 starts operating again so that the coins can be continuously sorted.

When the predetermined number of sorted coins is received in the first coin receiving tube 40a and thus the operation of the first motor 17 stops, the speaker 80 generates a predetermined sound to let the user know this.

Then, the user separates the first coin receiving tube 40a from the coin receiving tube moving unit 50 and takes the sorted coins out of the first coin receiving tube 40a. In addition, the user inserts the emptied first coin receiving tube 40a or another new coin receiving tube through the coin receiving tube insertion unit 60.

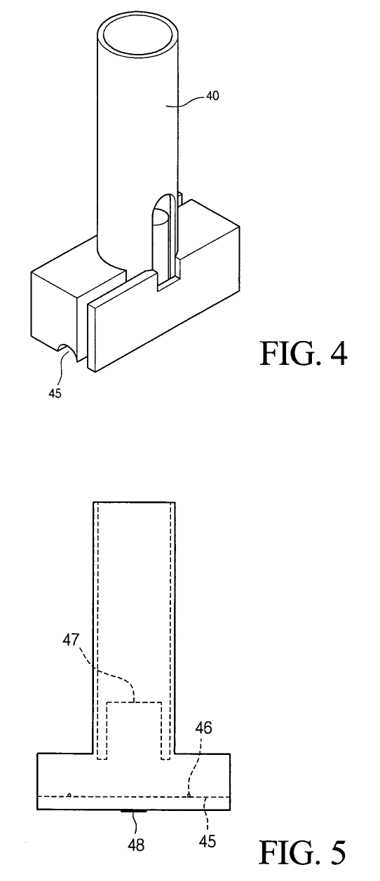

FIGS. 4 through 7 are views of the coin receiving tube according to the present invention.

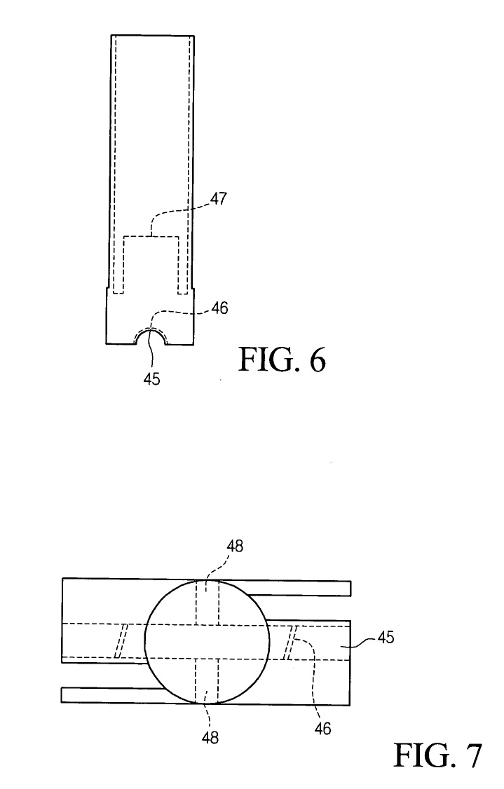

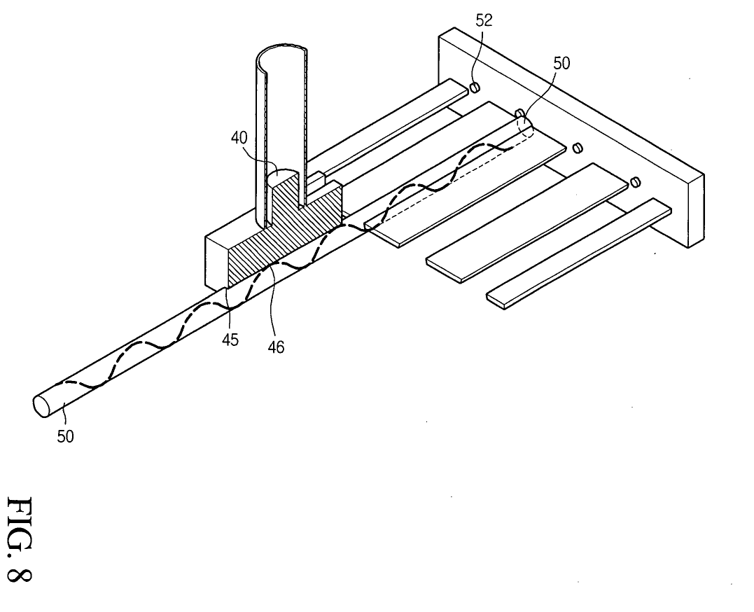

That is, FIG. 4 is a perspective view of the coin receiving tube, FIG. 5 is a side view of the coin receiving tube, FIG. 6 is a front view of the coin receiving tube, and FIG. 7 is a top view of the coin receiving tube.

Referring to FIGS. 4 through 7, the coin receiving tube 40 is further provided at a bottom surface with a contact portion 45 contacting the coin receiving tube moving unit 50, grooves 46 formed on the contact portion 45 and engaged with the coin receiving tube moving unit 50, and a coin stacking portion 46 on which the sorted coins are stacked.

As shown in FIG. 6, the contact portion 45 is concaved with a predetermined curvature. As shown in FIG. 7, each of the grooves 46 has a predetermined width and is obliquely arranged on the contact portion 45.

The coin-receiving tube moving unit 50 may be formed in a screw-shape. Therefore, the contact portion 45 is preferably formed in a hemispherical shape having a diameter similar to as an outer diameter of the coin receiving tube moving unit 50. Preferably, each of the grooves 46 is designed having a proper width that can coincide with that of the thread of the coin receiving tube moving unit 50 and obliquely arranged so that it can be easily engaged with the thread. As the coin receiving tube moving unit 50 rotates by the second motor 51, the coin receiving tube 40 effectively moves frontward.

In this embodiment, only two grooves 46 are formed on the coin receiving tube 40, the present invention is not limited to this. That is, more than two grooves 46 may be formed according to a length of the coin receiving tube moving unit 50.

Referring to FIG. 7, the first position sensor 43 is provided to detect if the coin receiving tube 40 is placed right below the guide unit 30. Preferably, the first position sensor 43 is installed on an opposing portion of an inner-bottom surface of the coin sorter 1 to the guide unit 30 since the proper position of the coin receiving tube 40 is right below the guide unit 30.

The first position sensor 43 is preferably installed at a portion sided outward from the center of the coin receiving tube 40 so that it can be spaced apart from the coin receiving tube moving unit 50 by a predetermined distance. By doing this, the first position sensor 43 can be installed without being interfered with the coin receiving tube moving unit 50.

In order for the first position sensor 43 to effectively detect the coin receiving tube 40, a sensor reflection plate 48 is preferably attached on the bottom surface of the coin receiving tube 40. Therefore, the detection reliability of the first position sensor 43 is improved to quickly sort the large amount of coins.

Referring to FIG. 7, the sensor reflection plate 48 is preferably installed to be sided from the center of the coin receiving tube 40 so that the sensor reflection plate 48 can be position right above the first position sensor 43 when the coin receiving tube 40 is placed below the guide unit 30.

Further preferably, the sensor reflection plate 48 is installed at both sides of the contact portion 40. In this case, the sensor reflection plate 48 is to be right above the first position sensor 43 even when the orientation of the coin receiving tube 40 varies during it is inserted through the coin receiving tube insertion unit 60.

FIG. 8 is a sectional view of line II-II′.

Referring to FIG. 8, the contact portion 45 formed on the bottom surface of the coin receiving tube 40 contacts the coin receiving tube moving unit 50. The grooves 46 formed on the contact portion 45 are engaged with the coin receiving tube moving unit 50 that is screw-shaped. In addition, the second position sensor 52 is installed above an end of the coin receiving tube moving unit 50 to detect if the coin receiving tube 40 can further move by the coin receiving tube moving unit 50.

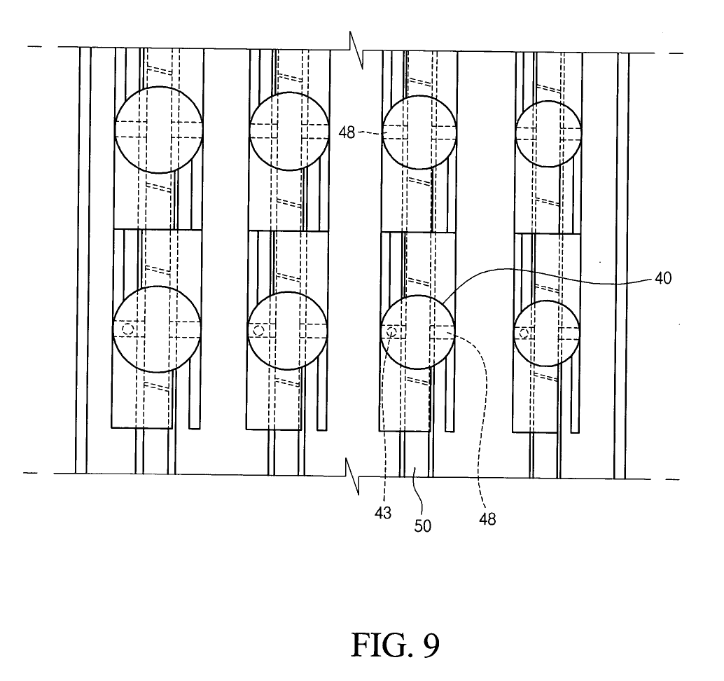

FIG. 9 is a view illustrating-the operation of the sensor unit.

As shown in FIG. 9, four coin receiving tubes are installed along a first line interconnecting four first position sensors 43. Four coin receiving tube moving units 50 are installed on second lines perpendicular to the first line. Four first position sensors 43 are installed to be sided from the center of the coin receiving tube 40 along the first line. Therefore, the coin sorter 1 of this embodiment can sort four types of coins that are different in a size from each other. However, the number of the coin receiving tubes and the number of corresponding sensors may vary according to the number of types of the coins that are currently used in each country.

Referring to FIG. 9, the sensor unit includes the first position sensor 43 for detecting if the coin receiving tube 40 is placed at a proper location for receiving the coins.

The operation of the sensor unit will now be described with reference to FIG. 9. The four first position sensors 43 arranged on the first line detect the coin receiving tubes. This means that the coin receiving tubes are placed at proper locations for receiving the coins. That is, the coins are received in the coin receiving tubes placed right below the guide unit 30.

Therefore, the sensor unit for detecting if the coin receiving tube is placed at a proper location for receiving the coins can be the first position sensor 43.

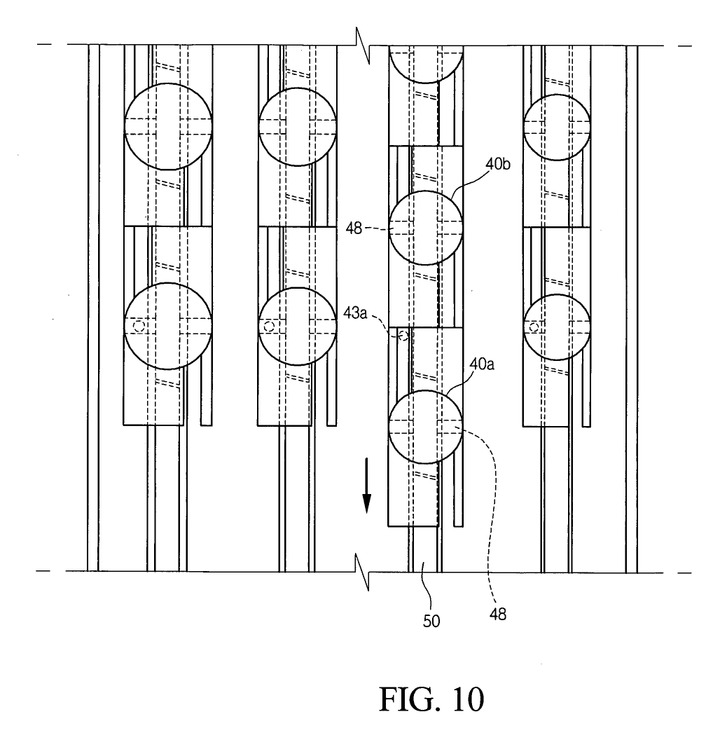

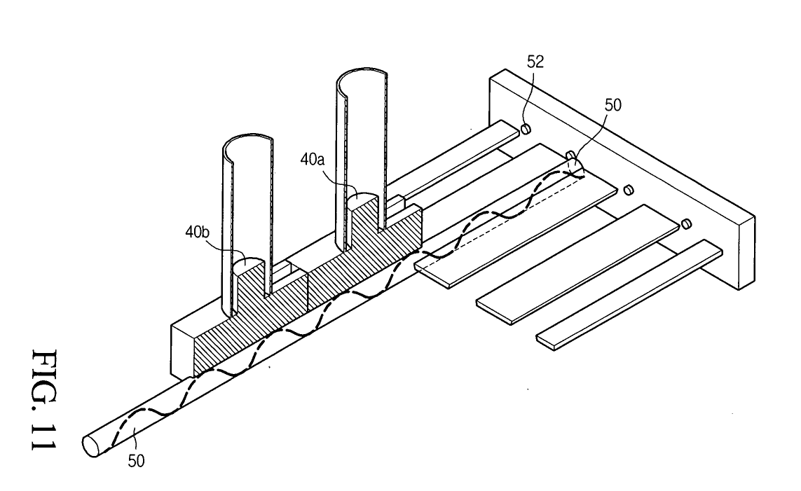

FIGS. 10 and 11 are views illustrating a process for moving the second coin receiving tube to a location below the guide unit.

Referring to FIGS. 10 and 1 1, when the predetermined number of coins are received in the first coin receiving tube 40a, the first motor 17 stops operating and second motor 52 starts operating by the control apparatus. The first coin receiving tube 40a and the second coin receiving tube 40b move frontward by the coin receiving tube moving unit 50.

At this point, the first position sensor 43a cannot detect the reflection signal. This means that the second coin receiving tube 40b is placed at a location where the second coin receiving tube 40b cannot properly receive the coins.

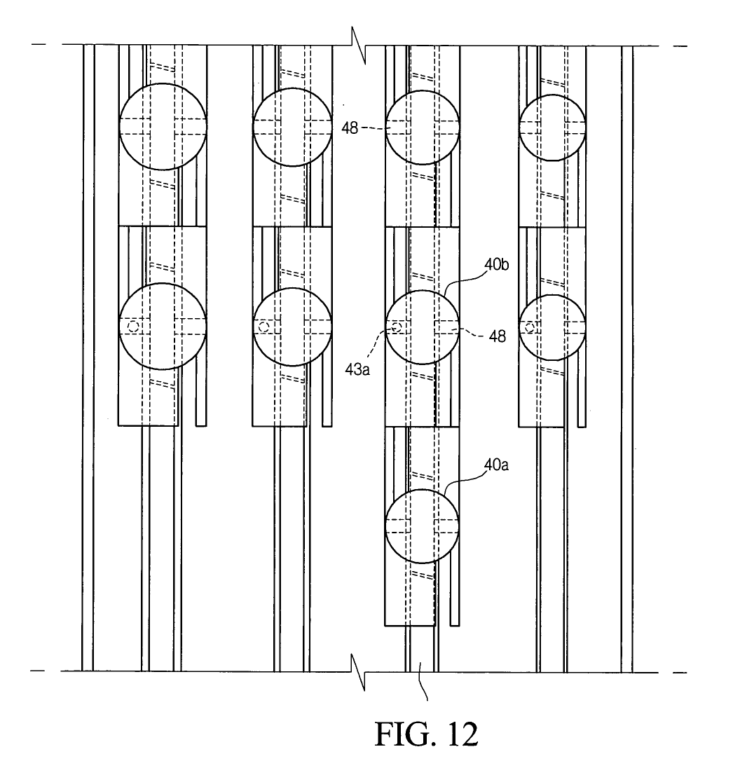

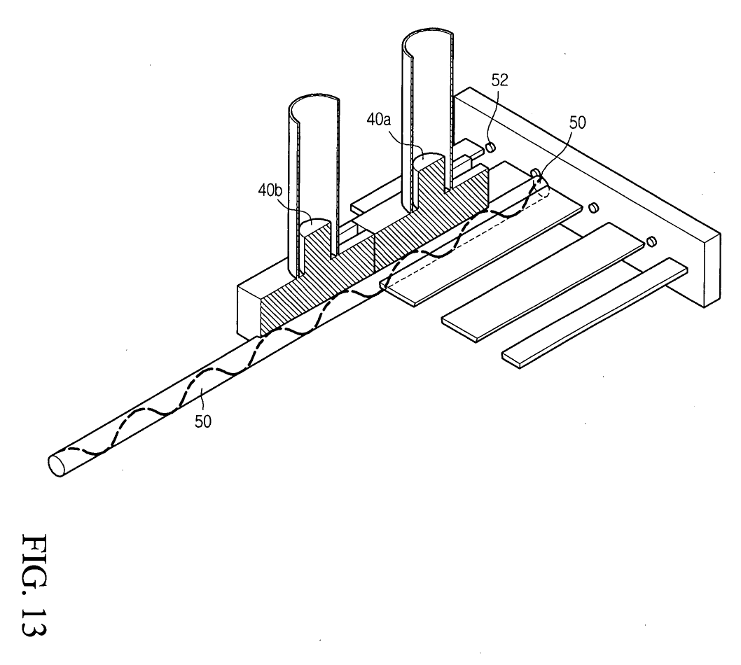

Therefore, the second motor 51 keeps operating and thus the first and second coin receiving tubes 40a and 40b keep moving frontward by the coin receiving tube moving unit 50. FIGS. 12 and 13 are views illustrating a process for receiving the coins in the second coin receiving tube placed below the guide unit.

Referring to FIGS. 12 and 13, as the first and second coin receiving tubes 40a and 40b move, the sensor reflection plate 48b of the second coin receiving tube 40b is aligned on the line interconnecting the sensor elements of the first position sensor 43.

At this point, the sensor elements of the first position sensor mutually transmit the signal through the sensor hole 41b. This means that the second coin receiving tube 40b is placed at a proper location for receiving the coins.

Therefore, the second motor 51 stops operating by the control apparatus and the first and second coin receiving tubes 40a and 40b stop moving. Then, the first motor 17 starts operating to keep sorting the coins. At this point, the sorted coins are received in the second coin receiving tube 40b.

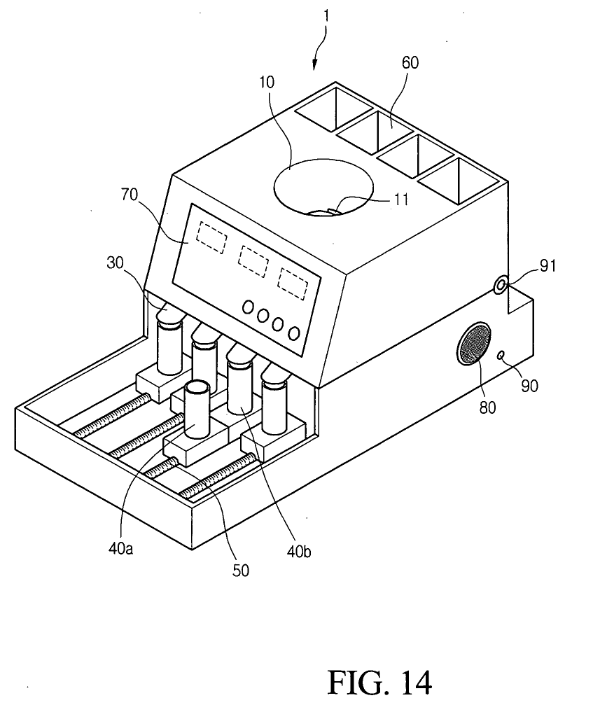

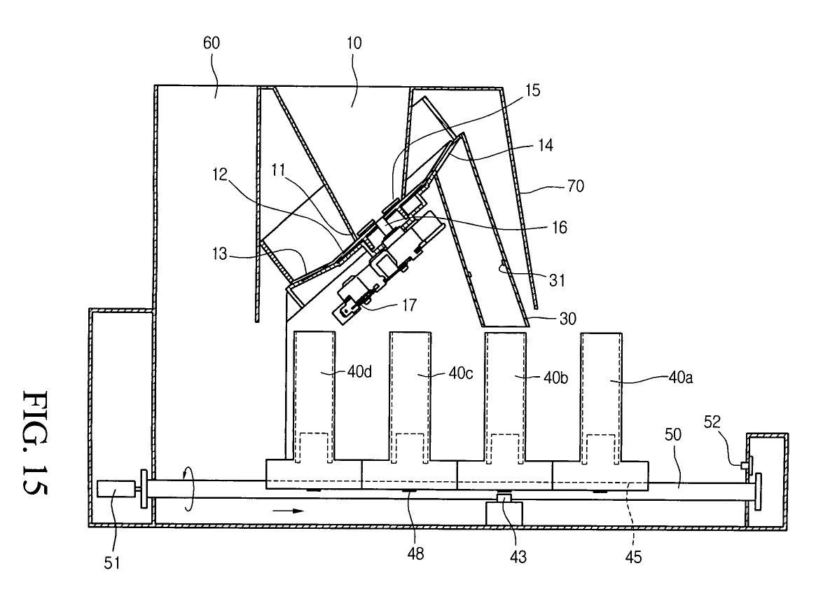

FIG. 14 is a view illustrating a state where the coins sorted by the coin sorting unit are being received in the second coin receiving tube placed below the guide unit.

FIGS. 15 through 18 are views illustrating a process for moving, separating and inserting the coin receiving tube.

Referring to FIGS. 15 through 18, the first, second, third, and fourth coin receiving tubes 40a, 40b, 40c, 40d in which a single type of coins are received are arranged adjacent to each other along the single coin receiving tube moving unit 50.

The first position sensor 43 for detecting the coin receiving tube placed below the guide unit 30 is formed on the inner bottom surface of the coin sorter I and the second position sensor 52 is installed on an upper portion of an end of the coin receiving tube moving unit 50 to detect if the coin receiving tube 40 can further move by the coin receiving tube moving unit 50.

The second motor 51 for rotating the coin receiving tube moving unit 50 is coupled to the coin receiving tube moving unit 50 and the coin receiving tube insertion unit 60 is formed on a rear portion of the coin sorter 1 so that the coin receiving tubes can be inserted downward through the coin receiving tube insertion unit 60.

In this embodiment, although four coin receiving tubes 40a, 40b, 40c, and 40d are arranged along the single coin receiving tube moving unit 50, the number of the coin receiving tubes that can be arranged on the single coin receiving tube moving unit 50 varies according to the length of the coin receiving tube moving unit 50.

FIG. 15 is a view illustrating a state where the second coin receiving tube 40b is placed at a proper location for receiving the sorted coins below the guide unit.

In this state, by the control apparatus, the second motor 51 stops operating and the first motor 17 starts operating so that the coins sorted by the coin sorting unit are received in the second coin receiving tube 40b.

At this point, the user separates the first coin receiving tube 40a from the coin receiving tube moving unit 50 and takes the coins out of the first coin receiving tube 40a.

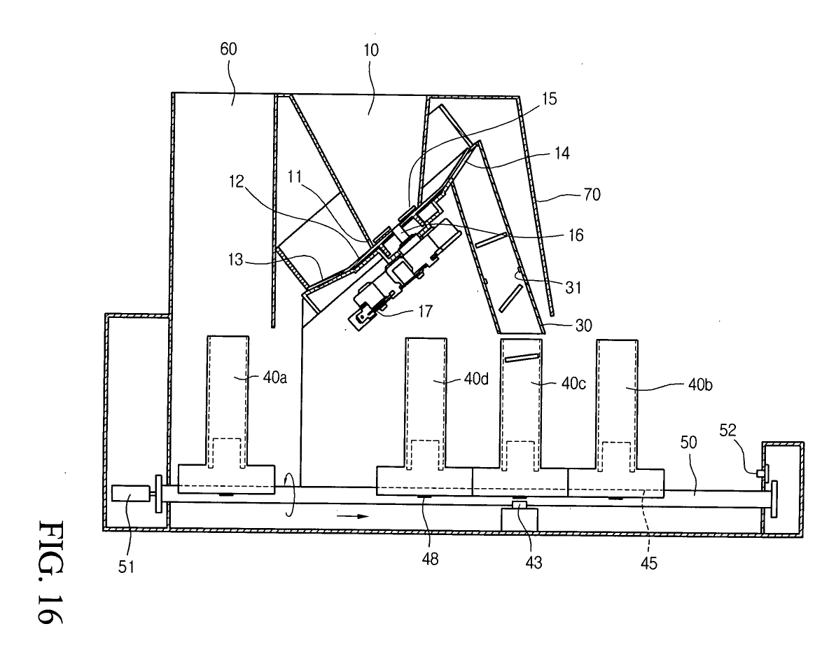

FIG. 16 is a view illustrating a state where the third coin receiving tube 40c is placed below the guide unit after the predetermined number of sorted coins are received in the second coin receiving tube 40b and the first coin receiving tube 40a is reinserted through the coin receiving tube insertion unit 60 by the user.

Therefore, while the user takes the sorted coins out of the first coin receiving tube 40a and packs the taken coins, the coins can be sorted and received in the second and third coin receiving tubes 40b and 40c. That is, since the coins can continuously be sorted without the user's manipulation, the large number of coins can be quickly sorted/packed.

At this point, since the user can supply the coin receiving tubes through the coin receiving tube insertion unit 60, the coin sorter can keep sorting without stopping.

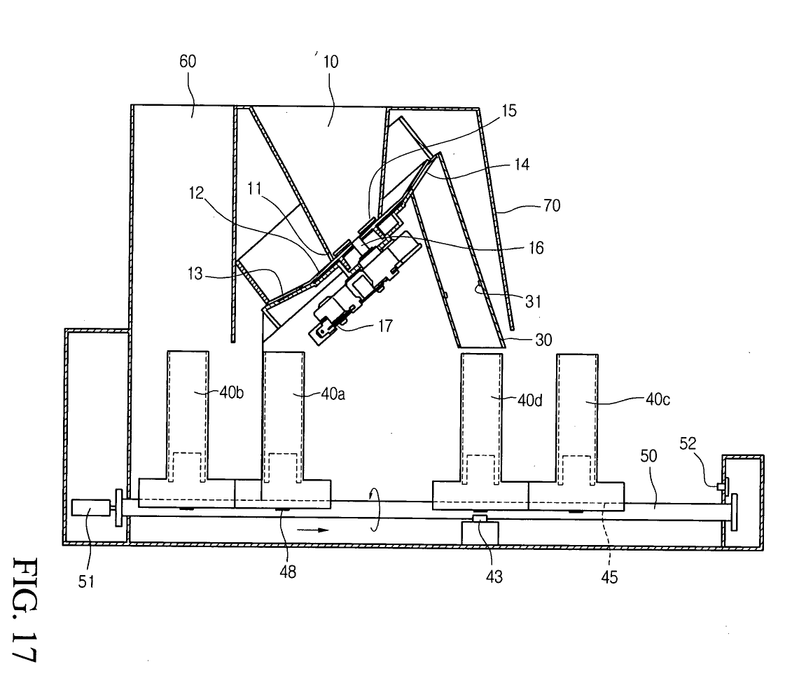

FIG. 17 is a view illustrating a state where the fourth coin receiving tube 40d is placed below the guide unit after the second coin receiving tube 40b is separated from the coin receiving tube moving unit 50 and reinserted through the coin receiving tube insertion unit 60.

In this state, by the control apparatus, the second motor 51 stops operating and the first motor starts operating so that the coins sorted by the coin sorting unit can be received in the fourth coin receiving tube 40d.

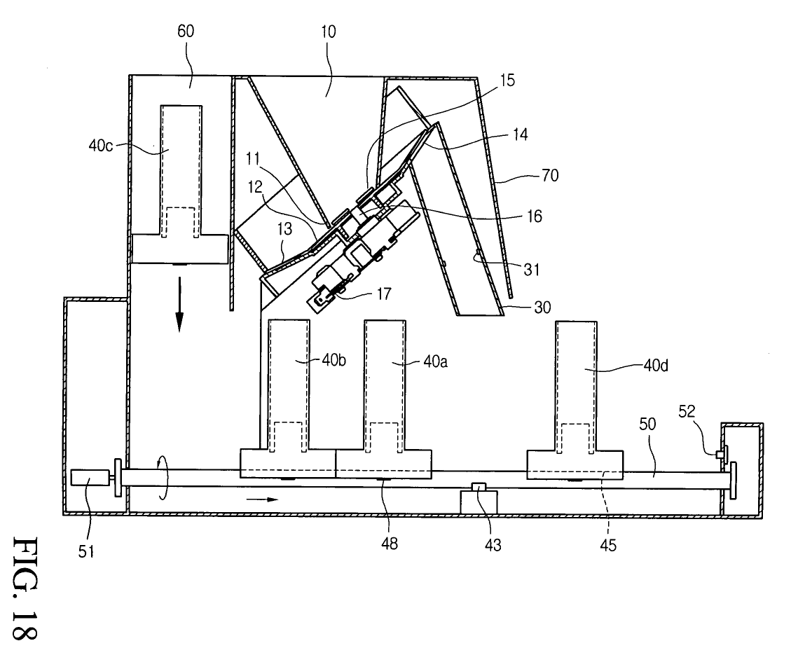

FIG. 18 is a view illustrating a state where the third coin receiving tube is being inserted through the coin receiving tube insertion unit 60 while the fourth, first and second coin receiving tubes 40d, 40a and 40b are moving.

In this state, the second motor 51 keeps operating until the sensor elements of the first position sensor 43 detect the receiving tube 40a.

As described above, since the coin receiving tubes can be continuously reinserted by the user, the coin sorter can keep operating without stopping.

That is, as far as the user stands by the coin sorter, since the coin sorter can keep operating, a large number of coins can be quickly sorted. Furthermore, since the user does the simple work for separating and inserting the coin receiving tubes, the convenience for the user can be improved.

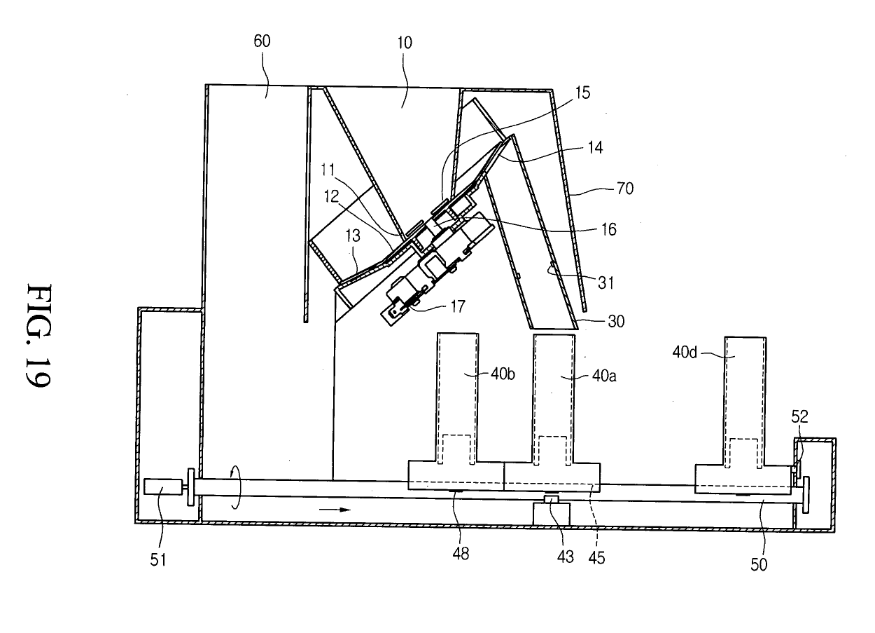

FIG. 19 is a view illustrating a process for operating the second position sensor 52.

Referring to FIG. 19, the second position sensor 52 is installed above an end of the coin receiving tube moving unit 50 to detect if the coin receiving tube 40 can further move by the coin receiving tube moving unit 50.

In FIG. 19, since the user does not separate the fourth coin receiving tube 40d from the coin receiving tube moving unit 50 and thus the second position sensor 52 detects the fourth coin receiving tube 40d by the operation of the second motor 5.1.

At this point, if the first coin receiving tube 40a is not placed below the guide unit, the second motor keeps operating. However, since the fourth coin receiving tube 40d is no longer movable frontward, the second motor 51 stops operating by the control apparatus, thereby stopping the operation of the coin sorter 1.

Therefore, when the user does not stand by the coin sorter or does not wish to operate the coin sorter, the operation of the coin sorter is automatically stopped, thereby preventing the coin receiving tubes and the coin receiving tube moving unit from being damaged and reducing the electric power consumption.

Meanwhile, as shown in FIG. 19, when the fourth coin receiving tube 40d is detected by the second position sensor 52 and the first coin receiving tube 40a is placed below the guide unit 30 as shown in FIG. 19, the second motor 52 stops operating and the first motor 17 starts operating to allow the coins sorted by the coin sorting unit to be received in the first coin receiving tube 40a.

When the predetermined number of coins is received in the first coin receiving tube 40a, the first motor 17 stops operating. However, since the fourth coin receiving tube 40d is detected by the second position sensor 52, the coin sorter stops operating.

Therefore, even when the second position sensor detects the coin receiving tube, if the coin receiving tube is placed to the proper location for receiving the coins, the coin sorter operates until the predetermined number of coins is received in the coin receiving tube, thereby sorting more coins.

The second position sensor 52 may be formed of a button type sensor that is pushed by the coin receiving tube that is not separated from the coin receiving tube moving unit. That is, the button type sensor is naturally pushed by the coin receiving tube moving by the coin receiving tube moving unit. Since the button type sensor is inexpensive as compared to other types of sensors, the cost for manufacturing the coin sorter can be reduced.

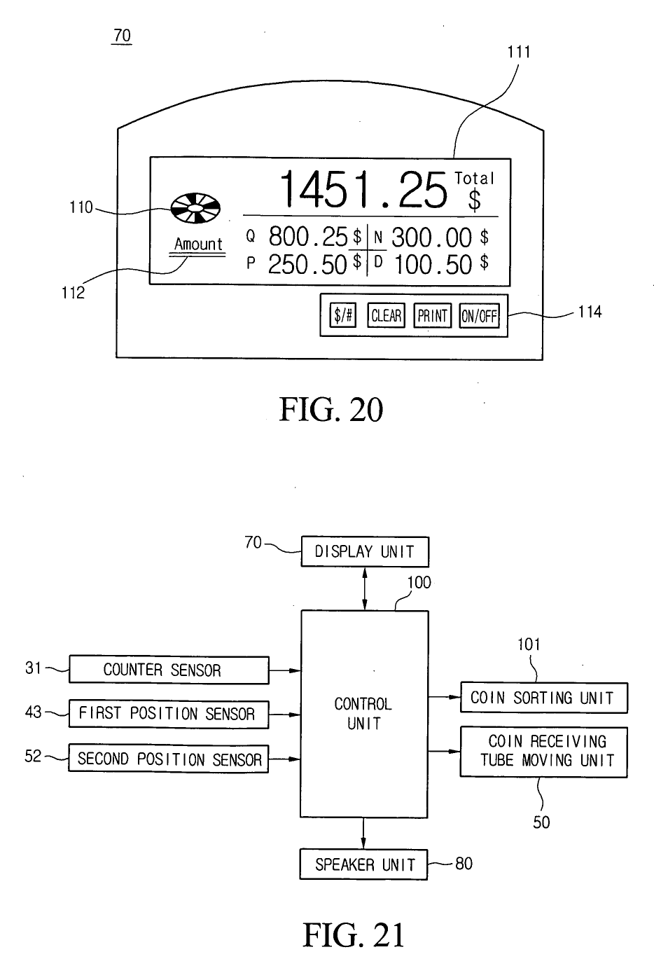

FIG. 20 is a view of the display unit of the coin sorter according to the present invention. Referring to FIG. 20, the display unit includes a plurality of manipulation buttons and a display window. The user can identify through an operation state display portion 1 10 if the coin sorter is operating. In addition, by manipulating a $/# button of a manipulation button portion 114, the user can identify the amount and number of sorted coins.

At this point, the amount and number of sorted coins is displayed on the display window 11. The user further identifies through an amount/number display portion 112 if the current number is the amount or number of the sorted coins.

Preferably, the number of coins is displayed within a predetermined range. When the user intends to pack the coins by 50-unit, the coin sorter is set such that 50 coins are received in each coin receiving tube. When the 50 coins are received in the coin receiving tube, the first motor stops operating.

Then, when a different coin receiving tube is placed to receive the coins by the second motor 51, the coins are continuously received in the different receiving tube. At this point, the amount of 50 coins that are already sorted is added to the amount of coins that are being currently sorted and the added amount is displayed. However, the number of coins that is being received in the current coin receiving tube is counted from “0” and is displayed.

Therefore, since the user can identify the current number of coins that is being received in the coin receiving tube, the user can predict the following operation of the coin sorter. Moreover, when the coin sorter stops operating in a state where the coins are not fully received in the coin receiving tube, the user can easily identify the number of coins received in the coin receiving tube.

When the user pushes a CLEAR button after the predetermined number of coins are sorted, the current data is deleted and the number and amount of coins that are newly sorted is displayed.

An ON/OFF button for turning ON/OFF the coin sorter is provided on the display unit 70.

When a PRINT button is pushed after an outer device such as a printer is connected to the communication port 90, the amount and number of the sorted coins can be printed out. A serial or infrared ray communication method may be used as the transmission method of the communication portion 90.

The serial communication method has a concept opposite to that of a parallel communication method. Since the serial method is inexpensive and easy connective, it is widely used as a connection method for connecting a peripheral device to a computer. This serial communication method is applied as a communication method of a mouse, a key board, a modem, and the like.

The infrared ray communication method is one of wireless local data communication technologies. It can be used for all of peripheral devices such as a connector, a printer, a personal computer, a personal digital assistant, and a local area network. Therefore, when the infrared ray communication method is used as the transmission method of the communication port 90, the coin sorter can be wirelessly connected to the outer device, improving the user convenience.

FIG. 21 is a view of a control apparatus of the coin sorter according to an embodiment of the present invention.

Referring to FIG. 21, the control apparatus of the coin sorter includes the counter sensor 31 for detecting the number of coins sorted by size, the first position sensor 43 for detecting if the coin receiving tube is placed at a proper location, the second position sensor 53 for detecting if the coin receiving tube can be moved toward a front portion of the coin sorter 1 by the coin receiving tube moving unit 50, a control unit 100 properly operating according to the signals transmitted from the from the counter sensor 31, the first and second position sensors 43 and 52, the coin sorting unit 101 selectively operating by the control of the control unit 100, the speaker 80 generating sound when the predetermined number of coins are detected by the counter sensor 31, and the display unit 70 displaying the current coin sorting state and having a plurality of buttons manipulated by the user.

In addition, the display unit 70 functions as a user-interface. That is, when the user allows the control unit 100 to stop or start the operation of the coin sorter or to display the amount and number of sorted coins on the display unit by manipulating the buttons of the display unit 70.

The speaker 80 outputs sound when a predetermined amount of coins are received in the coin receiving tube.

When the counter sensor 31 detects that the predetermined number of sorted coins is received in one or more coin receiving tubes, the counter sensor 31 transmits the corresponding signal to the control unit. Then, the control unit 100 controls the speaker to generate predetermined sound such as a voice or a melody so that the user can identify the current operation state.

The user controls the coin sorter through the display unit 70 and identifies the current operation state and the number and amount of the sorted coins.

The control unit 100 displays the total amount of the sorted coins on the display unit.

The control unit 100 displays the number of coins within a predetermined range. The highest value of the predetermined range is preferably the number of coins that will be received in a single coin receiving tube. The highest value is the unit number of the sorted coins that can be easily packed. For example, the coins can be packed by 50-unit. Therefore, the highest number may be set to be 50.

In this case, when the 50 coins are received in the coin receiving tube, the first motor 17 stops operating.

Then, when a different coin receiving tube is placed to receive the coins by the second motor 51, the number of coins is counted from “0.” That is, the number of coins that are being received in the coin receiving tubes that are identical in a size is displayed within a range of 0-50. The number (i.e., 50, 40, 150 or the like) that is a multiple of 50 can be separately displayed.

Therefore, the user can identify the current number of coins that is being received in the coin receiving tube.

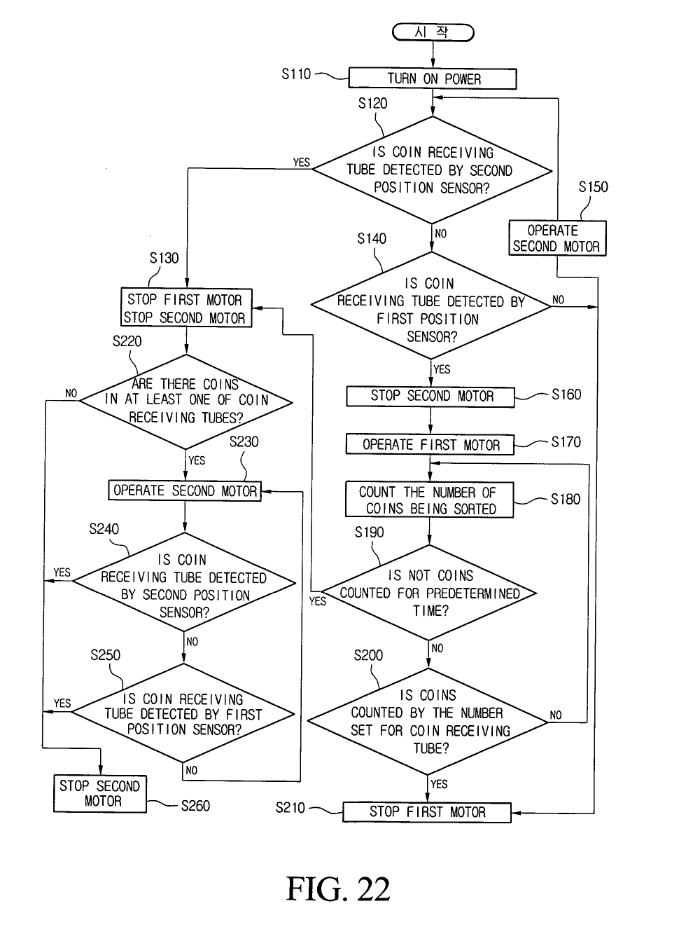

FIG. 22 is a flowchart illustrating the operation of the coin sorter.

When the user turns on the power (S100), the second sensor 52 detect if there is a coin receiving tube (S120). Then, the control unit 100 stops the first and second motors 17 and 51 by determining that there is no user standing by or the user does not want to sort the coins, thereby stopping overall operation of the coin sorter. At this point, it is preferable that the speaker 80 generates sound letting the user know the above.

Meanwhile, when the first position sensor 43 cannot detects the coin receiving tube in a state where the second position sensor 52 does not detect the coin receiving tube, the second motor 51 operates (S1 50) until the first position sensor 43 detects the coin receiving tube. This is to allow the coin receiving tube is located at the accurate position before the coin counting is done.

When the first position sensor 43 detects the coin receiving tube in a state where the second position 52 does not detect the coin receiving tube, the second motor 51 stops operating (S160) and the first motor 17 starts operating to sort the coins by sizes through the guide unit 30.

At this point, the counter sensor 31 counts the number of coins that is being sorted. When the user turns off the power or the number of sorted coins detected by the counter sensor 31 does not vary, the first motor 17 stops operating to stop the operation of the coin sorter 1 (S130). At this point, it is preferable that the speaker 80 generates sound to let the user know the operation stop of the coin sorter 1. (S190 and S130)

Meanwhile, when the coins are continuously sorted by the operation of the first motor 17 and thus a predetermined number of coins are received in at least one coin receiving tube, the first motor 17 stops operating and the second motor 51 starts operating. At this point, it is preferable that the speaker 80 generates sound to let the user know the operation stop of the coin sorter 1. (S150 and S210).

After the above, when the coin receiving tube moves by the coin receiving tube moving unit 50 frontward and the second position sensor 52 detects the coin receiving tube, the control unit 100 stops the first and second motors 17 and 51 by determining that there is no user standing by or the user does not want to sort the coins, thereby stopping overall operation of the coin sorter. At this point, it is preferable that the speaker 80 generates sound letting the user know the above. (S130 and S190)

Meanwhile, when the first position sensor 43 cannot detect the coin receiving tube in a state where the second position sensor 52 does not detect the coin receiving tube, the control unit 100 stops the operation of the second motor 51 operates and operates the first motor 17 so that the coins sorted by the coin sorting unit can be received in the coin receiving tube.

Meanwhile, when the second position sensor 52 detects the coin receiving tube or the number of the coins counted does not vary, or the power switch is turned off during the counting of the coins, the coin sorter 1 stops operating and the first and second motors 17 and 51 also stop operating.

At this point, when there are coins in at least one of the coin tubes (S220), the second motor 51 is driven after a predetermined time has lapsed so that the coin receiving tube moves frontward by the coin receiving tube moving unit 50. At this point, when the second position sensor 52 detects the coin receiving tube, the control unit 100 stops the operation of the second motor 51 by determining that the coin receiving tube is moved to a location where the user can easily take out the receiving tube from the coin sorter 1. At this point, it is preferable that the speaker 80 generates sound letting the user know the above. (S260)

In addition, the control unit identifies the number of coins that is stored in a microcomputer and it is determined that there are coins in any one of the coin receiving tube (S220), the second motor is driven to move the coin receiving tube frontward using the coin receiving tube moving unit 50. At this point, when the second position sensor 52 does not detect the coin receiving tube while the first position sensor 43 detects the coin receiving tube, the control unit 100 stops the operation of the second motor 51 by determining that the coin receiving tube is moved to a location where the user can easily take out the same from the coin sorter 1 and the coin sorter 1 stops operating.

At this point, it is preferable that the speaker 80 generates sound letting the user know the above. (S260)

Meanwhile, when there are coins in at least one of the coin tubes (S220), the second motor 51 is driven so that the coin receiving tube moves frontward by the coin receiving tube moving unit 50. At this point, when the first position sensor cannot detect the coin receiving tube in a state where the second position sensor 52 does not detect the coin receiving tube, the control unit 10 keeps operating the second motor by determining that the coin receiving tube is not moved to a location where the user can easily take the same out of the coin sorter 1. (S230) The operation of the coin sorter 1 according to the present invention will be briefly described again hereinafter.

The coins sorted at the coin sorting unit by the operation of the first motor 17 are received in the first coin receiving tube 40a through the guide unit 30. At this point, the number of sorted coins is counted by the counter sensor 31 installed on the inner surface of the guide unit 30.

When the predetermined number of coins is received in the first coin receiving tube 40a through the guide unit 30, the counter sensor detects this to stop the operation of the first motor and start the operation of the second motor through the control unit 100.

At this point, the control unit 100 generates the sound through the speaker 80 or displays the current state on the display unit 70 to let the user know the current operation state.

The first coin receiving tube 40a moves frontward by the coin receiving tube moving unit 50 operated by the second motor 51. At this point, when the first position sensor 43 detects the following coin receiving tube, the second motor 52 stops operating by the control unit 100 and the first motor 17 automatically starts operating to allow the coins to be received in the following coin receiving tube.

At this point, the control unit 100 displays the current state on the display unit 70 to let the user know the current operation state.

The number of coins detected by the counter sensor 31 does not vary for a predetermined time, the control unit 100 determines that all of the coins are sorted and stops the operation of the first motor 17 to stop the operation of the coin sorter 1.

When the second position sensor 52 detects the coin receiving tube, the control unit 100 determines that the user does not stand by the coin sorter 1 or does not wish to operate the coin sorter 1 and stops the operation of the second motor 51 to stop the operation of the coin sorter 1.

Meanwhile, when a predetermined time has lapsed after the coin sorter 1 stops operation and when there are coins in any one of the coin receiving tubes, the second motor 51 is driven to move the coin receiving tube containing the coins to a preferable location where the user can easily take the coin receiving tube out of the coin sorter. When the coin receiving tube is moved to the preferable location, the control unit 100 generates the sound through the speaker 80 or displays a current state on the display unit to let the user know the current state.

The user can identify the amount and number of the coins that are sorted or being currently sorted.

According to the present invention, as long as the user stands by the coin sorter, the coin sorter can keep operating, and a large number of coins can be quickly sorted. Furthermore, since the user does the simple work of removing and inserting the coin receiving tubes, the convenience for the user can be improved.

In addition, the movement of the coin receiving tube in which the coins are fully received is automatically done.

The coin sorter of the present invention can print out the number and amount of the sorted coins through an external device.

As described above, the coin sorter and the control apparatus thereof allow a large number of coins to be automatically sorted. Furthermore, since the coin sorter keeps operating without stopping by the user's simple manipulation, a large number of coins can be quickly sorted.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A coin sorter comprising:.
a coin supply portion through which coins that will be sorted are supplied;
a coin sorting unit for sorting the supplied coins by size;
a guide unit for guiding the sorted coins to a predetermined location;
a coin receiving tube for receiving the sorted coins delivered from the guide unit;
a coin receiving tube moving unit for moving the coin receiving tubes frontward; and
a coin receiving tube insertion unit through which the coin receiving tubes can be inserted.

2. The coin sorter according to claim 1, wherein the coin receiving tube insertion unit is opened at a rear portion of the coin sorter.

3. The coin sorter according to claim 1, wherein the coin receiving tube moving unit is formed in a screw shape.

4. The coin sorter according to claim 1, wherein the coin receiving tube includes a contact portion contacting the coin receiving tube moving unit and a groove formed on the contact portion.

5. The coin sorter according to claim 1, further comprising a hinge about which a coin sorter cover pivots to be opened and closed.

6. A coin sorter comprising:
a coin sorting unit for sorting coins by size;
a guide unit for guiding the sorted coins to a predetermined location;
a coin receiving tube for receiving the sorted coins guided by the guide unit;
a sensor unit for detecting if the coin receiving tube is placed at a proper location for receiving the sorted coins;
a coin receiving tube moving unit for moving the coin receiving tubes frontward;
a coin receiving tube insertion unit through which the coin receiving tubes can be inserted; and
a control unit for controlling the operation of the coin sorting unit and the coin receiving tube moving unit according to a signal transmitted from the sensor unit.

7. The coin sorter according to claim 6, wherein the sensor unit comprises a first position sensor for detecting if the coin receiving tube located under the guide unit is placed at the proper location where the coins can be properly received.

8. The coin sorter according to claim 7, further comprising a sensor reflection plate disposed in the coin receiving tube to allow the first position sensor to more accurately detect the coin receiving tube.

9. The coin sorter according to claim 6, further comprising a second position sensor for detecting if the coin receiving tube can be moved by the coin receiving tube moving unit.

10. The coin sorter according to claim 9, wherein the second position sensor is a button type sensor.

11. The coin sorter according to claim 6, further comprising a counter sensor for counting the number of coins that is being sorted, the counter sensor being formed on the guide unit, and a display unit for displaying information on the coins counted by the counter sensor.

12. The coin sorter according to claim 11, further comprising a communication port that can be connected to an external device to output information on the sorted coins.

13. The coin sorter according to claim 12, wherein a transmission method of the communication port is one of a serial method and an infrared ray method.

14. The coin sorter according to claim 6, further comprising a speaker for outputting sound according to an operation state of the coin sorter.

15. A control apparatus for a coin sorter, the control apparatus comprising:
a counter sensor for counting the number of coins that is being sorted;
a sensor unit for detecting if a coin receiving tube of a coin sorter is placed at a proper location for receiving the sorted coins;
a second position sensor for detecting if the coin receiving tube can move frontward;
a control unit for controlling the operation of the coin sorter according to signals transmitted from the counter sensor and the first and second position sensors;
a coin sorting unit selectively operated by the control unit; and
a coin receiving tube moving unit controlled by the control unit.

16. The control apparatus according to claim 15, wherein the sensor unit comprises a first position sensor for detecting if the coin receiving tube located under the guide unit is positioned to proper to receive the coins.

17. The control apparatus according to claim 15, further comprising a display unit for displaying information on the number of coins counted by the counter sensor having a plurality of manipulation buttons.

18. The control apparatus according to claim 15, further comprising a speaker is for outputting sound according to an operation state of the coin sorter.

19. The control apparatus according to claim 15, wherein the second position sensor detects if the coin receiving tube moving unit can move the coin receiving tube.

20. The control apparatus according to claim 15, wherein when the coin sorter stops operating, the control unit identifies the number of coins received in each coin receiving tube and, when a predetermined time has lapsed, the control unit moves the coin receiving tube to a location where a user can easily take out the coin receiving tube out of the coin sorter if there are coins in any one of the coin tubes.
